(19) United States
(12) Patent Application Publication
(10) Pub. No.: US 2014/0076095 A1
(43) Pub. Date: Mar. 20, 2014

(54) PEDAL WITH A « TT » (« PI ») SECTION PROVIDED WITH TILTED RIBS FOR REINFORCEMENT IN TORSION

(71) Applicant: MGI COUTIER, Champfromier (FR)

(72) Inventors: Pavan HEMMEGE VENKATAPPA, Conde sur Noireau (FR); Jacques GUEVEL BADOU, Falaise (FR)

(73) Assignee: MGI COUTIER, Champfromier (FR)

(21) Appl. No.: 14/014,473

(22) Filed: Aug. 30, 2013

(30) Foreign Application Priority Data
Aug. 31, 2012 (FR) 12/58169

(51) Int. Cl. G05G 1/44

(52) U.S. Cl. CPC G05G 1/44
USPC 74/512; 74/519

(57) ABSTRACT

The invention relates to a brake pedal (1) for a vehicle comprising a lever (6) provided with a hollow reinforcement segment (12) which comprises a longitudinal groove (13) with a <<pi>> cross-section on the one hand which opens onto the lower portion of the lever (6), said groove (13) being delimited by an upper wall (14) and two side walls (16), and at least two successive oblique reinforcement ribs (20, 120) oriented from the upper wall (14) towards the lower aperture (15) on the other hand, which each connect the left side wall (16) to the right side wall by subdividing the groove into several opening cavities (21, 121), such that in each cross-section (S1, S2, Si, . . . Sn) of the reinforced segment (12), the lever (6) has at least one closed contour for torsional reinforcement, formed by the contiguous succession of corresponding sections of the upper wall (14), forming a first crosspiece, of the left side wall (16), forming a first upright, of a rib (20, 120, 220, 320) forming a second crosspiece, and of the right side wall, forming a second upright.

### TECHNICAL FIELD

The present invention relates to the general field of control pedals, for example intended for fitting out control pedal assemblies of automobile vehicles, in order to allow the user and more particularly the driver to control any function, such as acceleration, clutch disengagement or else further braking.

### BACKGROUND

Many types of brake pedals are already known, which generally comprise a shoe mounted on a pivoting lever so as to allow conversion of a thrust force, exerted by the foot of the user on the shoe, into a compressive or tensile force actuating a brake rod attached to said lever.

Because of the intensity and of the repeated nature of the stresses to which the levers of brake pedals will be subject, both in flexure and in longitudinal torsion, by the application of thrust forces often offset relatively to their middle plane, said brake pedals should show particularly great robustness and rigidity.

This is why known pedals generally have metal sheet structures with a large thickness, cut out and stamped, or quite massive, made from particularly robust materials such as steel or aluminum, and sometimes reinforced by a network of ribs.

Thus, from document EP-1 331 150, a brake pedal of the <<composite>> type is for example known, which has an <<I-shaped>> cross-section consisting of a metal core in steel or in aluminum, lined with upper and lower cover walls as well as ribs in an injected plastic material.

Now, if such pedals generally give satisfaction as to their mechanical behavior, they may however have some drawbacks.

Indeed, the use of metal bearing elements on the one hand and of a large network of intertwined ribs on the other hand, which support wide cover walls, gives this type of pedal a structure which nevertheless remains relatively bulky and heavy.

Of course, this goes against the intention, now a constant intention, of lightening vehicles and their different constitutive members.

Further, the complexity of such a composite pedal, which integrates several components made in different materials, the respective forming of which involves distinct methods, tends to complicate the manufacturing process of such a pedal, by multiplying the transformation steps and by imposing the use of complex and expensive tooling.

### BRIEF SUMMARY

The objects assigned to the invention therefore aim at finding a remedy to the aforementioned drawbacks and proposing a novel type of pedal, in particular a brake pedal, which reconciles compactness, lightness, and robustness, notably in torsion, while having a simple structure which is easy and not expensive to manufacture.

The objects assigned to the invention are achieved by means of a pedal comprising a lever which extends longitudinally from a shoe, intended to receive a control force, to a articulating member intended to allow pivoting of said pedal around a pivot axis, said pedal being characterized in that said lever has a hollow reinforced segment which comprises:

a groove which extends longitudinally along a mean line oriented from the shoe towards the articulating member, on the one hand, said groove having a <<π>> (Greek letter <<pi>>) shaped cross-section so as to open on the outside of the lever through an aperture which extends along said lever on one of the sides of the latter, said groove being delimited, around the mean line and along the latter, by a bottom wall located opposite to the aperture relatively to the mean line of said groove, and by two side walls, i.e. a first side wall, a so-called <<left side wall>>, and a second side wall, a so-called <<right side wall>>, which extends from said bottom wall by edging sideways said groove on either side of the mean line, and

at least two successive reinforcement ribs, distant from each other, which extend obliquely with respect to the mean line, from the bottom wall towards the aperture, on the other hand, and which each connect the left side wall to the right side wall so as to subdivide the groove into several cavities which open onto said aperture, said reinforcement ribs being sufficiently close to each other, in view of their tilting relatively to the mean line of the groove, for exhibiting along the groove, in an orthogonal projection on said mean line, a partial longitudinal overlap so that in each cross-section of the reinforced segment occupied by said reinforcement ribs, the lever has at least one closed contour for torsional reinforcement, which is formed by the contiguous succession of the corresponding sections of the bottom wall, forming a first crosspiece, of the left side wall, forming a first upright, of a rib forming a second crosspiece, and of the right side wall, forming a second upright, and which at least frames a cavity passage.

Advantageously, the invention first of all gives the possibility of making a lightened pedal, since it has a highly <<open>>, hollow bearing infrastructure of the honeycomb type, made with a relatively limited amount of material with view to the overall volume which it occupies.

In spite of this lightness, the pedal according to the invention may retain good compactness and more particularly low bulkiness for a great predetermined load capacity, because it intrinsically has, notably by the layout of the reinforced segment, great structural rigidity, and more particularly a high inertia modulus, not only against flexure but also against torsion which results from the offset application of the control force.

Indeed, the side walls of the groove, which support in length the side wall, advantageously act as a pair of stiffeners, placed as an over-thickness of said bottom wall, which efficiently reinforce the bending resistance of the lever.

For example, it is thus possible to reinforce the resistance of the lever to longitudinal bending (pitch-bending) by positioning said side walls substantially vertically under a bottom wall which caps them.

Also, the particular oblique and overlapping layout of the ribs specific to the invention, gives the possibility of generating in each cross-section of the reinforced segment, or even more globally of the lever, the equivalent of a closed frame, the uprights (formed with the sections of the side walls) of which and the crosspieces of which (formed with the sections of the upper wall and of the rib(s) obliquely crossing the relevant cross-section), give said frame stiffness, and more particularly a high inertia modulus in torsion, similar to those of a profile.

Thus, in other words, in any section of the reinforced segment, or of the lever, perpendicular to the torsional moment which results from the application of the control force, there exists a closed profile (contour) which participates in the resistance to the torsional forces (in roll here).

As such, it will be noted that said uprights and crosspieces advantageously frame one or several recess(es) (of the <<windows>> kind) corresponding to the passage(s) of cavity(ies) intersecting the considered cross-section, or even, more preferentially also frame the mean line of the groove.

Advantageously, this continuous succession along the reinforced segment, or even the lever, of sections each having a closed contour, produces on the whole of the reinforced segment an overall increase in the resistance to torsion, while preserving the lightness of the structure.

Moreover, the simplicity of the shape of the pedal according to the invention as well as the consistent orientation of the walls of the ribs and of the cavities which all preferentially open towards the same side, for example downwards, give the possibility of contemplating the existence of at least one common mold removal direction, stemming from the corresponding side, for example from below, of the lever and pointing towards the inside of the groove and towards the bottom wall, a common mold removal direction towards which the whole of the surfaces delimiting the ribs, as well as the whole of the walls of the cavities, have a positive or zero draft angle.

Thus, the pedal is optimized for its making by molding, and more particularly by injection molding, in one pass, by means of simple tooling.

In particular, it becomes possible to make the pedal without using retractable cores.

The manufacturing of the pedal according to the invention may thus be fast, and furthermore efficient as regards raw materials, tooling and energy.

Finally, the specific structure of the pedal allows the latter to integrate and combine the performances and advantages, nevertheless contradictory at first glance, of robustness, flexural and torsional stiffness, lightness, compactness and manufacturing simplicity.

According to other optional embodiments of the invention:

the reinforcement ribs each join the bottom wall as far as a free end which is located beyond half the depth of the groove in the direction of the aperture, and preferably which is flush with the edges of the left and right side walls;

each reinforcement rib forms a planar partition with substantially constant thickness, and in that the reinforcement ribs are parallel with each other;

some of the reinforcement ribs, preferably the majority, or even the totality of said reinforcement ribs are laid out perpendicularly to the left and right side walls;

the reinforcement ribs are made in one piece with the left and right side walls;

the reinforcement ribs are made in one piece with the bottom wall;

the bottom wall forms a plate which marks the limit, for example the upper limit, of the lever and which preferably juts out in width protruding from the left and right side walls;

the reinforced segment covers at least 30%, at least 50% or even at least 75% of the length of the lever;

the filling level of the pedal, corresponding to the quotient of the solid volume of said pedal by the total volume of the cover of said pedal is substantially comprised between 5% and 50%.

the lever, and preferably the pedal as a whole, is entirely made in one piece in a material suitable for injection molding, preferably selected from a thermoplastic polymer, either filled with fibers or not, a composite material filled with fibers either woven or not, or a metal alloy of the aluminium or magnesium type;

at least one of the reinforcement ribs has a tilt combined in roll, and then in pitch relatively to the mean line and in that this composed tilt reinforcement rib is crossed with another rib also having a tilt composed in roll, of opposite sign, and then in pitch, so as to form inside the groove an oblique cross, the generatrix of which extents away from the bottom wall along a resulting tilt in pitch relatively to the mean line, and which opens onto the aperture;

the groove is laid around the mean line (L) so as to have a C-shaped section, the aperture of which is located on the side of the lever, transversely to the pivot axis;

the pedal comprises two opposite grooves by their common bottom wall so as to form a dual reinforced segment having, depending on the orientation, either an I-shaped section, or an H-shaped section, both corresponding reinforcement rib series being preferably laid out in a herringbone pattern;

the bottom wall is divided into a second series of reinforcement ribs positioned at a distance from the reinforcement ribs of the first series, and oriented according to directions intersecting said ribs of the first series, the reinforcement ribs of the second series being preferably laid out in an oblique pattern and/or staggered relatively to the reinforcement ribs of the first series.

Moreover, the invention provides an automobile vehicle provided with a control pedal assembly comprising at least one pedal, preferably a brake pedal, the pedal being according to the invention.

### BRIEF SUMMARY OF THE DRAWINGS

Other objects, features and advantages of the invention will become more apparent in detail upon reading the following description, as well as by means of the appended drawings, purely provided as an illustration and not as a limitation, wherein:

FIG. 1 illustrates, according to a perspective view, an embodiment of a pedal according to the invention.

FIG. 2 illustrates, according to a schematic side view, the implantation of the pedal of FIG. 1 on a control pedal assembly.

FIG. 3 illustrates, according to a bottom view, the pedal of FIGS. 1 and 2.

FIG. 4 illustrates, according to a sagittal sectional view along a sectional plan A-A perpendicular to the articulating axis, the structure of the pedal of FIGS. 1 to 3.

FIGS. 5 and 6 illustrate successive cross-sections of the lever of the pedal of FIG. 4, in the sectional planes B-B and C-C.

FIGS. 7, 8 and 9 represent various possible alternatives of cross-sections of a lever and more particularly of a reinforced segment according to the invention.

FIG. 10 illustrates, according to a bottom view, a second reinforced segment layout alternative, applied here within a pedal of the type illustrated in FIGS. 1 and 2.

FIG. 11 illustrates, according to a sagittal sectional view along a sectional plane A2-A2, perpendicular to the articulating axis, the structure of the pedal of FIG. 10.

FIGS. 12 and 13 illustrate successive cross-sections of the lever of the pedal of FIG. 11, in the sectional planes B2-B2 and C2-C2.

FIGS. 14, 15 and 16 illustrate, according to a perspective view from the top, to a perspective view from the bottom and to a median sectional detailed view A3-A3 respectively, an alternative embodiment of a pedal according to the invention, the articulating member of which is formed by a yoke instead of a solid single terminal portion.

FIGS. 17, 18, 19, 20 and 21 illustrate, according to a perspective view, a sagittal sectional view, a side view and two successive cross-sectional views respectively, a third alternative embodiment of a reinforced segment according to the invention.

FIGS. 22, 23, 24, 25 and 26 illustrate, according to a perspective view, a sagittal sectional view, a side view and two successive cross-sectional views respectively, a fourth alternative embodiment of a reinforced segment according to the invention.

FIGS. 27, 28, 29, 30 and 31 illustrate, according to a perspective view, a sagittal sectional view, a side view and two successive cross-sectional views respectively, a fifth alternative embodiment of a reinforced segment according to the invention.

### DETAILED DESCRIPTION

The present invention relates to a pedal 1, of the control pedal kind intended for actuating any mechanism and more particularly a brake pedal designed so as to be implanted in a vehicle in order to be able to actuate a braking device, preferably an assisted braking device.

For this purpose, and as this is illustrated in FIG. 2, the pedal is preferably mounted on a base 2, itself preferentially attached on the floor or the firewall 3 of the vehicle, a base 2 on which said pedal is pivotally articulated about a pivot axis (XX′), so as to be able to drive an actuator 4, for example a brake rod or cable, preferably in compression, when said pedal pivots under the stress of a control force F, exerted by the foot of the user.

Of course, the invention also relates to a control pedal assembly 5 comprising at least one pedal 1, preferably a brake pedal according to the invention or even a plurality of pedals among which one or several pedals 1 according to the invention.

The present invention also relates to a vehicle, and notably to an automobile vehicle, preferably with wheels, intended for example for individual or collective transportation of persons or goods, which is provided with such a control pedal assembly 5.

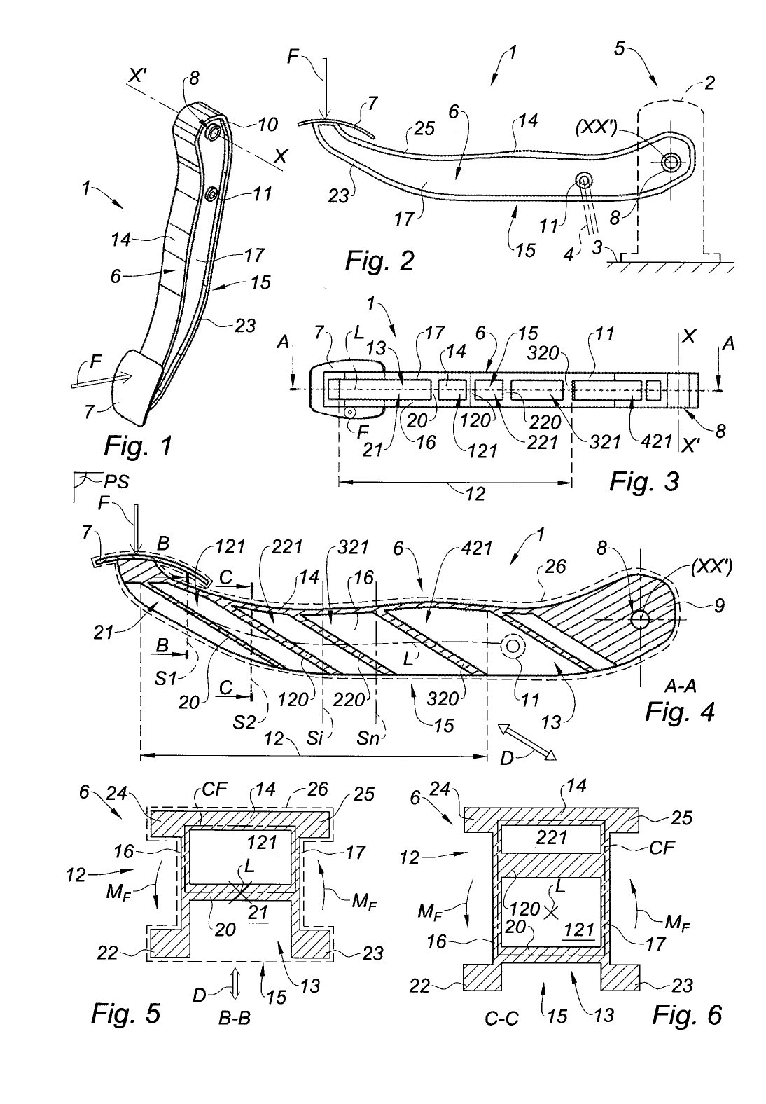

As this is illustrated in FIGS. 1 to 4, 10, 11, 14, 15, the pedal 1 comprises a lever 6 which extends longitudinally from a shoe 7, intended to receive a control force F, as far as a articulating member 8 intended for allowing the pivoting of said pedal and more particularly of said lever 6, about the pivot axis (XX′), under the effect of said control force F.

By convention or by simple convenience of description, it will be considered that the predictable control force F, in principle exerted by the foot of the user, is oriented in the top to bottom direction and preferably along a substantially vertical direction, as this is illustrated in FIGS. 2 and 4.

The shoe 7 may advantageously appear as a solid or openworked platelet, preferably slightly convex outwards, and preferentially substantially oriented normal to the predictable application direction of the control force F.

Said shoe 7 will preferably be fixed, or even integrated, substantially to a first end of the lever 6, and more globally of the pedal 1, in the upper portion of said lever 6, and it may optionally be provided with padding and/or anti-slip forms, such as ridges or such as a sleeve in elastomeric material.

The articulating member 8, preferably located at a second end of the lever 6, and more globally of the pedal 1, may comprise any male or female element with which it is possible to receive or materialize the pivot axis (XX′).

As this is illustrated in FIGS. 1, 2, 4, 10 and 11, said articulating member 8 may advantageously be formed with a smooth bore drilled in a solid terminal portion 9 of the lever 6, forming a single branch here, which is crossed right through by said bore along the pivot axis (XX′). Said bore may optionally extend sideways on either side of the central body of the lever, by means of protruding barrels 10 which increase its range.

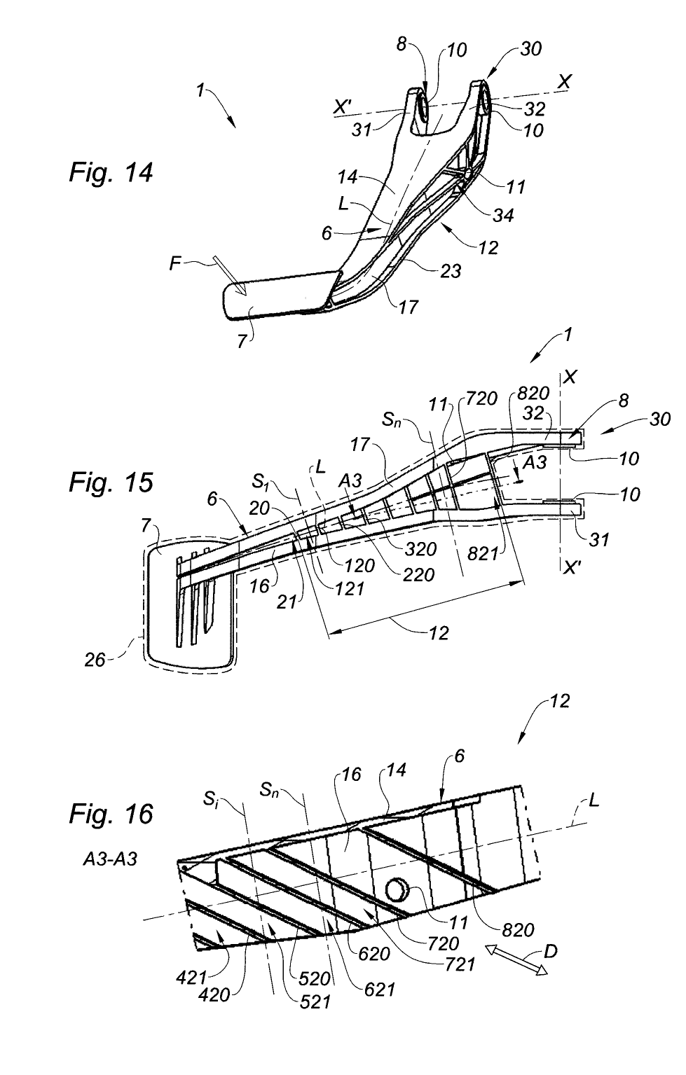

Conversely, the articulating member may include, as this is illustrated in FIGS. 14 and 15, a yoke 30 comprising a left branch 31 and a right branch 32.

Said branches 31, 32 will preferably be each drilled with a bore, preferentially extended with a barrel 10.

Regardless of the layout of the articulating member 8, the junction with the base 2 may be simply and directly accomplished by means of an axle, of the trunnion or pin kind, engaged in the bore(s), either tightly engaged or freely guided in rotation.

Of course, any equivalent device may be contemplated, the jointed member 8 may for example integrate a journal bearing, or further ball or roller bearing(s), or even include solid protrusions forming male trunnions intended to cooperate with conjugate bearings made in the base.

The lever 6 will moreover comprise advantageously a coupling member 11 intended to receive the end of the brake rod 4. Said coupling member may for example be formed with a transverse circular eyelet which crosses at least one wall of the lever so as to be able to receive a hook or U-bolt present on the brake rod 4.

The coupling member 11 may also be arranged so as to form a ball-joint connection with the end of the brake rod.

Said coupling member 11 will preferably be located in an intermediate area of the lever 6 closer to the second end of said lever 6, bearing the axis (XX′), than to the first end bearing the shoe 7.

According to the invention, the lever 6 has a hollow reinforced segment 12.

According to the invention, said reinforced segment 12 comprises a groove 13 on the one hand, which extends longitudinally along a mean line L oriented from the shoe 7 to the articulating member 8, said groove 13 having a <<π>> (Greek letter <<pi>>) shape cross-section so as to open on the outside of the lever 6 through an aperture 15 which extends along said lever 6 on one of the sides of the latter.

Said groove 13 is delimited, around the mean line L, and along said mean line L, by a bottom wall (14) located opposite to the aperture 15 relatively to the mean line L of said groove (13), and by two side walls, namely a first side wall, a so-called <<left side wall>> 16, and a second side wall, a so-called <<right side wall>> 17, which extend from said bottom wall 14 by laterally edging said groove 13 on either side of the mean line L.

Said groove 13 will thus be preferably edged, around the mean line L, on three of its sides, and open on the fourth.

By mere description convenience, the <<mean line>> L will be considered in the usual sense of beam theory, the groove 13 being assimilated with a beam generated by a planar surface (<<cross-section>>), normal to said mean line and the center of gravity of which describes a curve which forms said mean line L.

The shape of said mean line is by no means limited, the latter may for example substantially form a straight-line segment (FIGS. 3, 4, 10, 11, 18, 23, 28), preferably perpendicular to the pivot axis (XX′), or further a broken line (FIG. 15), or a curvilinear line, or even a piecewise combination of these elements.

Of course, the <<pi>> section is by no means limited to a particular shape or dimensions.

Thus, the <<pi>> may be straight, the side walls 16, 17 being substantially perpendicular to the bottom wall 14 (FIGS. 5, 6, 7, 9, 12, 13, 20, 21, 25, 26), or else the <<pi>> may be open like a trapezium, the side walls 16, 17 diverging from the bottom wall 14 (FIG. 8).

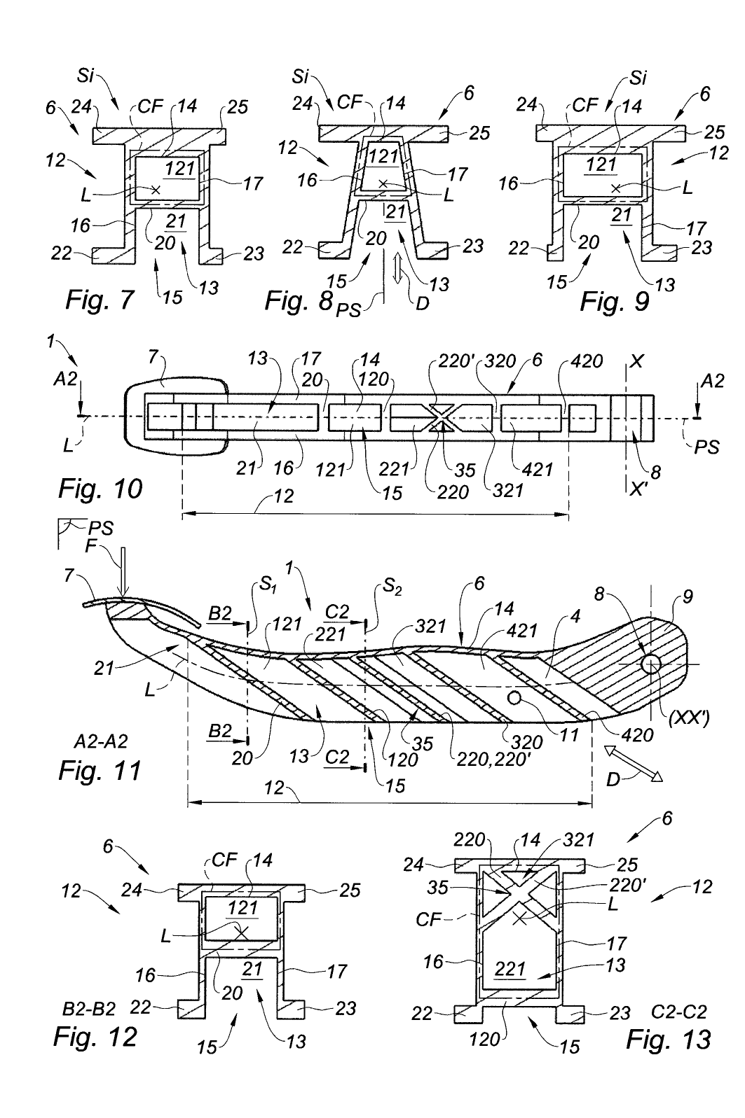

Said <<pi>> section may also be dissymmetrical (FIGS. 7 and 9), or on the contrary substantially symmetrical (FIGS. 5, 6, 8, 12, 13, 20, 21, 25, 26) relatively to the sagittal plane PS of the groove 13, which preferably corresponds to the plane normal to the pivot axis (XX′) and parallel with, or even containing, the mean line L.

The external contour of the <<pi>> section may be smooth, and thus form a substantially U-shaped or C-shaped section (FIGS. 20 and 21 for example), or else on the contrary have protrusion(s) such that projection(s) 24, 25 protruding from either one of the side walls on either side of the bottom wall, and/or bulge(s) 22, 23 on either one of said side walls (FIGS. 5, 7, 8, 9, 12, 13 for example).

Further, the shape and/or the dimensions, notably the overall dimensions, of the cross-sections of a same reinforced segment 12, and more globally of the lever 6, may be constant or on the contrary vary along the mean line.

In particular, said overall dimensions may increase upon covering the mean line L in the direction from the shoe 7 to the articulating member 8, for example increasing in height (FIGS. 4, 11 and 14) and/or in width (FIGS. 14 and 15).

Whatever the nature of its cross-section(s), the groove 13 may be oriented differently relatively to the pivot axis (XX′) without departing from the scope of the invention.

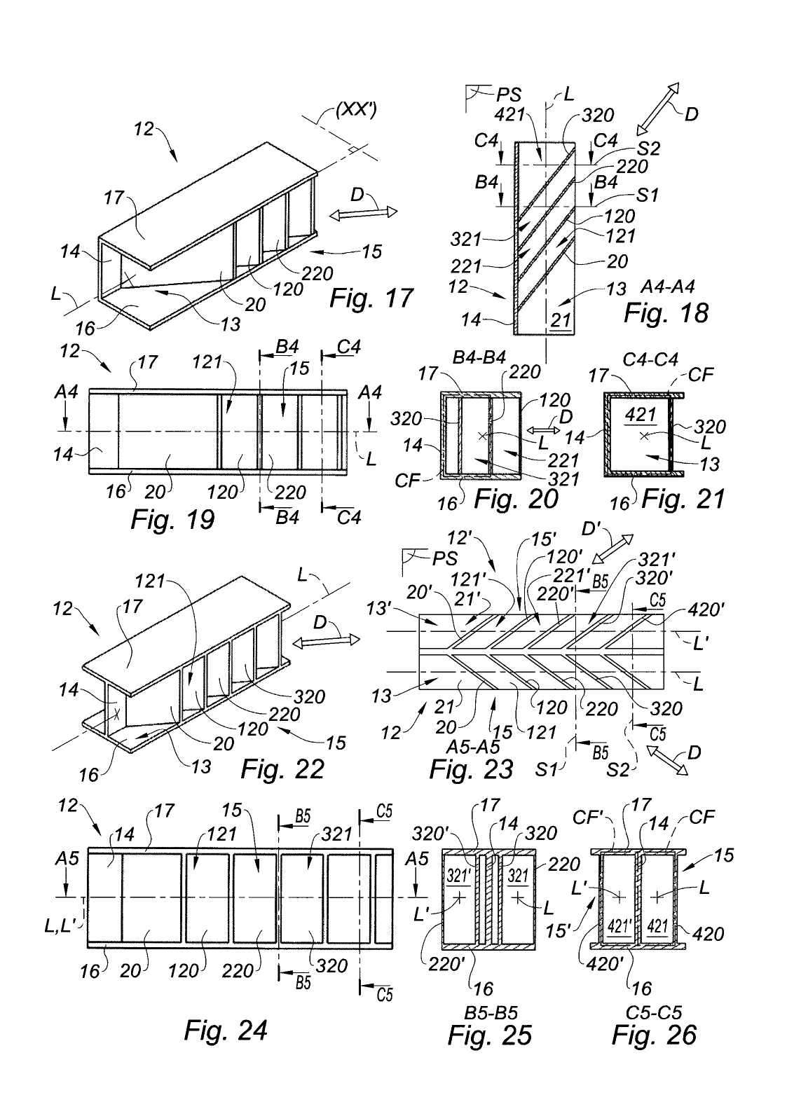

According to a preferential arrangement, notably corresponding to FIGS. 1 to 16, but which may also find application to the alternatives of FIGS. 17 to 21, and especially FIGS. 22 to 26 and 27 to 31, the bottom wall 14 may form an upper wall, from which the left and right side walls 16, 17 will preferably fall substantially vertically, possibly substantially perpendicularly to said upper wall.

In other words, the groove will preferably open towards the underside of the lever 6.

The side walls may then form side faces of the lever 6, preferentially substantially normal to the pivot axis (XX′) as this is visible in FIG. 5, 6, 7, 9, 12 or 13 for example.

Advantageously, the groove 13 may thus have as a cross-section, a hollow base substantially shaped as a <<U>> upside down closed on three sides and open on the fourth side, downwards, which longitudinally sweeps through the reinforced segment 12, or even globally through the majority if not the totality of the lever 6, along a mean line L, thereby generating a kind of open blind gutter opposite to the shoe 7 and to the application point of the control force F.

According to this layout, and because of the presence of these left and right side walls 16, 17 forming stiffeners, of the continuous rail type, against the force F, the groove 13 advantageously has a high inertia modulus and therefore good stiffness, against the bending in pitch.

However, it may be considered differently orienting the aperture 15, for example laterally, by making said aperture on one side face of the lever 6, the <<pi>> section being thereby <<laid>> as compared with the previous alternative, for example by a 90 degree permutation about the mean line L, as this is notably illustrated in FIGS. 17, 22 and 27.

Preferably, the bottom wall 14/aperture 15 orientation will in this case substantially correspond to the direction of the pivot axis (XX′), while one of the side walls, here the second <<right>> side wall in FIGS. 17, 22 and 27, will be oriented towards the control force F.

In this configuration, the side walls 16, 17 will this time act as stiffeners against the lateral flexure in yaw.

In every case, as this is illustrated in FIGS. 1, 2, 4, 10, 11, 14 and 15, the shoe 7 may advantageously be fixed, or even integrated into the upper portion of the lever 6.

Thus, according to alternatives of FIGS. 1 to 4, 10, 11, 14 and 15, the shoe 7 will be integrated onto the upper bottom wall 14, protruding and/or overhanging said bottom wall 14 and will thus be found on the opposite side to the lower aperture 15 and to the left and right side walls 16, 17, relatively to said bottom wall 14.

Moreover, regardless of their layout and orientation, the side walls 16, 17 may be of constant thickness, along the lever 6.

The side walls 16, 17 may further be convex laterally outwards, or on the contrary concave, or else further substantially parallel with each other, so that the groove 13 has substantially constant width.

The side walls 16, 17 may moreover be locally provided on their external face opposite to the recess of the groove 13, with raised/recessed stiffeners 34, of the rib kind, for example positioned in a star pattern around the coupling member 11, as this is notably visible in FIG. 14.

According to an alternative embodiment, as this is visible in FIGS. 3 and 10, said left and right side walls 16, 17 will be rectilinear between the shoes 7 and the axis (XX′).

However, according to a preferential alternative embodiment, said left and right side walls 16, 17 will follow a broken or bent mean line L, or even will gradually diverge from said mean line, like a cornet flaring out towards the pivot axis (XX′), as this is illustrated in FIGS. 14 and 15.

As an indication, the thickness of each side wall 16, 17 may be substantially comprised between 0.5 mm and 10 mm and that of the upper wall 14 may be comprised between 1.5 mm and 20 mm.

The reinforced segment 12 according to the invention also comprises on the other hand, at least two successive reinforcement ribs 20, 120, 220, 320, 420, 520, 620, 720, 820, etc., distant from each other, which extend obliquely relatively to the mean line L, from the bottom wall 14 towards the aperture 15 and which each connect the left side wall 16 to the right side wall 17 so as to subdivide the groove 13 into several cavities 21, 121, 221, 321, 421, 521, 621, 721, 821, etc. which open onto the lower aperture 15.

According to the invention, as this is notably illustrated in FIG. 4, 10, 16, 18, 23, or 28, the reinforcement ribs 20, 120, 220, 320 are sufficiently close to each other, in view of their tilt relative to the mean line L of the groove 13, so as to exhibit, along said groove 13 in an orthogonal projection on said mean line L, partial longitudinal overlapping so that, in each cross-section S1, S2, Si, . . . Sn of the reinforced segment 12 occupied by said reinforcement ribs 20, 120, 220, 320, the lever 6 has, as this is illustrated in FIGS. 5 and 6, at least one closed contour CF for torsional reinforcement, formed by the contiguous succession of the corresponding sections of the upper wall 14, forming a first crosspiece, of the left side wall 16, forming a first upright, of a rib 20, 120, 220, 320, 420, 520, 620, 720, 820 forming a second crosspiece, and of the right side wall 17, forming a second upright.

Advantageously, said closed contour CF frames at least one cavity passage 21, 121, 221, 321, 421, 521, 621, 721, 821.

Thus, although the reinforcement ribs 20, 120, 220, 320, 420, 520, 620, 720, 820 are advantageously disconnected one from the other so as to allow free access from the outside, and more particularly from the aperture 15, to the bottom wall 14, via the cavities 21, 121, 221, 321, 421, 521, 621, 721, 821, the said reinforcement ribs 20, 120, 220, 320, 420, 520, 620, 720, 820 are laid out pairwise so that longitudinally, along the increasing abscissas of the mean line L, a new rib 120 begins in the area of the bottom wall 14, before the previous rib 20 ends in the area of the lower aperture 15.

As such, it will be observed that in the longitudinal overlapping area, i.e. in the interval of the abscissas simultaneously occupied by two successive ribs 20, 120, 220 etc., each cross-section of the reinforced segment 12 comprises, as this is illustrated in FIG. 6, 20 or 30, at least three crosspieces, among which the two lower crosspieces are formed by the sections of the longitudinally overlapping ribs, staged in the bottom wall 14/aperture 15 direction, i.e. vertically in FIG. 6 and horizontally in FIGS. 20 and 30, as well as (at least) two separate cavities each surrounded by a closed contour.

Advantageously, the layout of the invention gives the possibility of having, in any cross-section normal to the torsional moment M_{F} generated by the control force F, the equivalent of a closed frame, for example a rectangular frame (FIGS. 5, 6, 8, 9, 12, 20, 25, 30 notably), a square frame or a trapezoidal frame (FIG. 8), which locally gives a high torsional inertia modulus, while having nonetheless, by the cavities reserved by the inter-rib spacing, a hollow, <<lightened>> and therefore lightweight structure, furthermore open on one face, for example on the underside of the lever, since the tilt, preferably in pitch, and the shape of the transverse reinforcement ribs also give the possibility of having all the cavities open directly on the same face, for example a lower face, of the lever 6.

This latter feature makes the inside of the groove 13 and more particularly said cavities and the walls which delimit them, easily accessible, and more particularly easily <<removable from the mold>> for example from below in FIGS. 4, 11, 15, by a lateral approach in FIG. 17, 20, 22 or 27.

In other words, the invention advantageously enables, in any section S1, S2, Si, Sn substantially normal to the torsional moment M_{F}, closing the groove 13 on its fourth side, at a distance from the upper wall 14 (and here opposite to the point of application of the control force F) with crosspiece(s) formed by the corresponding ribs 20, 120, so as to obtain in said section a closed contour profile CF, while keeping a longitudinally oblique access, inside said contour, by the tilt of the corresponding cavity(ies) 21, 121, 221.

As regards said access, it will be noted that, as this is illustrated in FIG. 4, the walls 14, 16, 17 of the groove 13, as well as the ribs 20, 120, 220, 320 which delimit the cavities 21, 121, 221, 321 will preferably be arranged so that there exists, as this is illustrated in FIGS. 4, 8, 11, 16, 18, 23 and 28, at least one spatial direction D here stemming from the underside of the lever and pointing towards the bottom wall 14, which forms a possible mold removal direction common to said cavities, towards which the whole of the surfaces of the aforementioned walls and ribs have a positive or zero draft angle.

Such a layout will of course promote making of the pedal by molding, notably by injection molding, with relatively simple tooling.

Moreover, the reinforced segment 12, and more particularly the groove 13 may preferably extend along a mean line L which will be in majority, if not in totality, substantially perpendicular to the predictable mean direction (here a vertical direction in FIGS. 2, 4, 11 and 14) of application of the control force F, which will allow substantial assimilation, in a first approximation and by convenience of description, of the <<structural>> cross-sections S1, S2, Si, Sn of the lever 6, normal to the mean directing line L of said lever, with the <<functional>> cross-sections, normal to the torsional moment M_{F}, in the sense of beam theory, cross-sections which are notably oriented along a direction parallel to the direction of application of the control force F.

This being the case, the shape and the dimensions of the lever 6, as well as the location, extent and geometry of the reinforced segment 12, as well as the implementation and orientation of the pedal 1 inside the vehicle, may freely be the object of highly diverse selections, the principle of the invention may advantageously be adapted mutatis mutandis, notably by adjusting the number, the tilt angle and the value of the gaps separating the ribs, from case to case.

As such, the tilt of the ribs 20, 120, 220, 320, etc. relatively to the mean line L, as well as the height of said ribs considered between their root oriented towards the bottom wall 14 and their free end oriented towards the aperture 15, and therefore their position and extent in abscissas along the mean line L, will advantageously be defined so as to keep the closing feature of the CF contour in each section normal to the torsional moment M_{F} generated by the control force F, notably taking into account some tolerance towards the uncertainty cone in which the tilt of said force F, according to which said force F is applied on the pedal, may vary during normal operation of said pedal 1.

Moreover, although the cavities 21, 121, 221, 321, 421, etc. are preferably intended to remain empty, it is not excluded that they may, one and/or the other, be partly or totally filled with lightweight material, of the polymeric foam kind, of lower density than the material(s) forming the walls of the groove 13 and the ribs 20, 120, 220, 320, for example for improving the aesthetical finish of the pedal or else its vibratory behavior.

Preferably, the reinforced segment 12 will include more than two successive distinct reinforcement ribs, longitudinally overlapping pairwise, in order to ensure continuity of the presence of closed contours CF in the normal successive sections along said segment.

Thus, said reinforced segment 12 may include at least three, or even at least four reinforcement ribs 20, 120, 220, 320 of this type, occupying the inside of the groove 13, or even more.

Preferentially, said reinforcement ribs are entirely contained in said groove 13, without jutting out from said groove, i.e. without protruding beyond the walls 14, 16, 17 or the aperture 15 which delimit said groove.

For example it is possible to give a smooth and aesthetical finish to the lever 6, and to the pedal 1, notably on its upper and lateral apparent faces, which notably makes it less subject to fouling.

Preferably, the reinforcement ribs 20, 120, 220, 320 each join the bottom wall 14 up to a free end located beyond, and more particularly located below, half the depth of the groove 13 in the direction of the aperture 15, said free end being preferably flush with the edges of the left and right side walls 16, 17, as this is illustrated in FIG. 4, 11, 16, 18, 23, 28.

In other words, each oblique reinforcement rib covers more than 50% and preferably the totality of the depth of the groove 13. This contributes to improving the stiffness of the lever 6, notably by facilitating and increasing the longitudinal inter-rib overlapping, while simplifying the molding tooling.

Preferably, each reinforcement rib 20, 120, 220, 320, etc. forms a planar partition of substantially constant thickness, and possibly substantially equal from one rib to the other.

As an indication, the thicknesses of said ribs may substantially be comprised between 0.5 mm and 10 mm, preferably between 1.2 mm and 5 mm.

Further, said ribs are preferentially parallel with each other.

Advantageously, such an arrangement facilitates molding, because it is compatible with a shared oblique mold removal direction D substantially parallel to said ribs.

As such, the lever 6, and more particularly the reinforced segment 12, will preferably be provided with reinforcement ribs which do not intersect each other, so as to have, notably with respect to their opening face and more particularly with respect to their lower face (FIGS. 4 and 10) or side face (FIGS. 18, 23, 28), and in particular in the sagittal plane PS of the groove 13, a structure <<removable from the mold>> without any counter-ribs.

Preferably, the reinforcement ribs 20, 120, 220, 320 are arranged perpendicularly to the left 16 and right 17 side walls.

Here again, such an arrangement first of all gives the possibility of balancing the structure of the pedal, and of notably observing its symmetry relatively to the sagittal plane of the lever, but of also giving great resistance to the lever both in torsion and in yaw lateral bending, and of finally simplifying the manufacturing of said pedal by molding.

However, according to an alternative embodiment, and regardless of the arrangement of the lever 6, it is possible to consider having a first series of reinforcement ribs, 20, 120, 220 etc., such as described hereinbefore, at least one 220 of said ribs having a tilt combined in roll, and then in pitch relatively to the mean line L.

Preferably, this reinforcement rib 220 with a composed tilt, is crossed with another rib 220′ also having a composed tilt in roll, of opposite sign, and then in pitch, so as to form inside the groove 13 an oblique cross 35, the generatrix of which extents away from the bottom wall 14 along a resulting tilt in pitch relatively to the mean line, and which opens onto the aperture 15, as this is illustrated in FIGS. 10, 11 and 13.

Preferably, the tilt in pitch of said generatrix is identical with the tilt in pitch of the neighboring reinforcement ribs, and collinear with the mold removal direction D.

Of course, this teaching is applicable mutatis mutandis to a laid groove which opens sideways.

Preferably, whatever their layout, the reinforcement ribs 20, 120, 220, 320 are made in one piece with the left 16 and right 17 side walls.

Further, said reinforcement ribs are preferably made in one piece with the bottom wall 14 in the same material.

Advantageously, such a monolithic assembly of the reinforcement ribs with the groove which they support is particularly robust and furthermore, by the suitable shape of the lever, is simple and fast to obtain by molding.

By the way, the lever 6 and preferably the pedal 1 as a whole, notably including said lever 6, the shoe 7 and the articulating member 8, is preferentially entirely made in one piece in a material suitable for injection molding, preferably selected from a thermoplastic polymer, either filled with fibers or not, a composite material filled with fibers either woven or not, or from a metal alloy of the aluminium or magnesium type.

If necessary, said polymeric material may form the matrix of a reinforced composite material with fibers, for example aramide, glass, carbon, Kevlar® fibers or any other fibers or mixture of reinforcement fibers either woven or not.

Advantageously, producing such a monolithic pedal may be achieved in a single injection molding step in a rapid, reproducible and reliable way with simple tooling and moderate energy consumption.

The thereby obtained pedal from a not very dense, although mechanically resistant, material is furthermore particularly lightweight.

According to a preferential arrangement, notably visible in FIGS. 1, and 5 to 16, the bottom wall 14 forms a smooth, preferably solid covering plate which marks the limit, for example an upper limit, of the lever 6, and which preferably juts out in width, protruding from the left and right side walls 16, 17.

Advantageously, the top of the pedal 1 may thus be formed with a smooth and continuous upper wall 14 which gives the lever 6 both its stiffness, notably against bending in yaw, and aesthetical finish.

As such, it will be noted that preferably, no element of the lever vertically protrudes above the upper wall 14 on the side of the application force F except for the shoe 7 which overhangs said upper wall.

Here again, the layout of the pedal 1 simplifies the making of the latter, while guaranteeing the required mechanical performances.

This arrangement of the bottom wall 14 as a terminal smooth plate may also be applied, mutatis mutandis, within a C-shaped <<laid>> arrangement, the plate marking the limit of one of the faces, here the left face, of the lever 6, as this is illustrated in FIGS. 17 and 18.

Besides, the bottom wall may be substantially linear, not branched, possibly with substantially constant thickness over the whole length of the reinforced segment 12, or even over the whole length of the lever 6.

Moreover, as this is notably visible in FIGS. 1, 2, 5 to 9, 12, 13 and 14, the free ends, here preferably lower ends, of the left and right side walls may include, preferably continuously over the whole of their length, bulges of materials 22, 23 which protrude sideways towards the outside of the groove 13, on either side of the lower mouth of the latter, as an overthickness of said side walls.

Like the left 24 and right 25 lateral projections which protrude from the upper wall 14, and which are preferably substantially vertical above said left 22 and right 23 bulges, the bulges 22, 23 may have a substantially rectangular cross-section.

Advantageously, these structures will contribute to stiffening the left and right side walls 16, 17, notably against lateral bending, in yaw (from left to right or vice versa) in the aforementioned figures.

On each side face of the lever 6, the bulge 23 and the projection 25 may advantageously join up, notably through a circular fillet surrounding the solid terminal portion 9, so as to form a continuous border all around the periphery of said side face, as this is notably visible in FIGS. 2 and 14.

Further, these arrangements remain compatible with simple molding, by for example providing the possibility of forming a mold divided into (only) three portions, one portion of which, here preferentially a lower portion, having the width of the groove 13 and forming the core common to the cavities 21, 121, 221, 321, 421, said core having the counter-form of the ribs and cavities, and two side portions, preferably substantially symmetrical, forming lateral flanges which join up, below on the edge of the groove 13, at the limit of the first portion, and at the top into the sagittal plane of the pedal, forming a mould joint, said lateral flanges each comprising the counter-print of a half shoe 7, of an upper half-wall 14 of one of the left and right side walls 16, 17 and left and right lateral projections 24, 25 and associated bulges 22, 23.

Preferably, the reinforced segment 12 covers at least 30%, at least 50%, or even at least 75% of the length of the lever 6, and in particular of the length comprised between the center of the shoe 7, where the control force F, will be applied, and the pivot axis (XX′).

It is thus possible to combine significant lightening with efficient reinforcement, notably upon torsion, over a great length, over the majority or substantially over the totality, of the pedal 1.

In a particularly preferential way, the reinforced segment 12 may extend from the shoe 7 at least up to the coupling member 11 intended to receive the brake rod 4, i.e. in a particularly stressed area upon actuation of the pedal, or even further beyond this point, up to the articulating member 8.

Moreover, according to a preferential feature which may form an invention on its own, the filling level of the pedal 1 corresponding to the quotient of the full volume of said pedal 1 and more particularly of the volume of its supporting frame infrastructure (shoe 7, left and right side walls 16, 17 and upper walls 14, reinforcement ribs, 20, 120, 220, 320, articulating member 8, terminal portion 9) by the total volume of the envelope 26 of the said pedal 1 is substantially comprised between 5% and 50%.

In this case, the volume difference between the full volume, filled with supporting material, and the total envelope 26 volume, said envelope volume being illustrated in dotted lines in FIGS. 4, 5 and 15, substantially corresponds to the volume cleared by the cavities 21, 121, 221, 321, 421.

Of course, the invention is by no means limited to a particular alternative embodiment, one skilled in the art may notably adapt, isolate or combine together either one and/or both of the features described in the foregoing.

Thus, in particular, it is possible to contemplate varying the path of the lever 6, and more particularly of the mean line L of the groove 13, provided that the arrangement of the ribs, taking into account the geometry of the lever 6 as well as the predictable application point and orientation of the control force F, meets the criterion for reinforcing the structure by closing the profile in the sections which are normal to the torsional moment generated by said control force.

Also, it would also be conceivable that the pedal be arranged so as to urge the actuator 4 in traction rather than in compression.

Moreover, as this has been stated above, the groove 13 may be laid around the mean line L so that it has a C-shaped section, the aperture 15 of which is located on a side face of the lever 6, substantially transverse to the pivot axis (XX′), as this notably illustrated in FIGS. 17, 20, 21, 22, 25, 26, 27, 30 and 31.

According to this alternative, the closed contour CF and its reinforcement role upon torsion are again found, but with a 90 degree permutation of the upright relatively to the crosspieces.

In this configuration, the bottom wall 14 and the oblique reinforcement ribs 20, 120 are now the ones which are used as stiffeners towards the bending in pitch, while the so-called side walls 16, 17 are efficiently opposed to the side bending in yaw.

According to another alternative embodiment, illustrated in FIGS. 22 to 26, it is possible to combine two grooves 13, 13′ opposed by their common and preferably central bottom wall 14 so as to form a dual reinforced segment 12, 12′ having according to the orientation, either an I-shaped section or an H-shaped section.

Each groove, 13, 13′ may have its own reinforcement ribs 20, 120, 20′, 120′, etc., as well as its own cavities, 21, 121, 21′, 121′, etc. arranged according to the invention.

Both respective apertures 15, 15′ of the grooves 13, 13′ allow molding along two convergent mold removal directions D, D′ (right-left for the I-shaped section, top-bottom for the H-shaped section).

The first series of ribs 20, 120 etc., and the second series of ribs 20′, 120′, 220′, 320′, 420′ may have equal or different pitch, or be arranged with a herringbone pattern (FIG. 23) or else on the contrary shifted longitudinally staggered relatively to each other along the mean line, for example by a half-pitch.

In every case, the two series of ribs will preferably be arranged with an angled pattern, the ribs of the first series globally forming with their counter-parts of the second series, flared structures, because said ribs all tend to diverge from the same bottom wall 14, on either side of the latter, along the mean line in a given direction.

Preferably, all the ribs will have the same thickness. Both grooves 13, 13′, and more particularly the two series of reinforcement ribs, will preferably be arranged symmetrically relatively to their common bottom wall 14, or at least with their respective mean lines L, L′ which are substantially parallel one to the other.

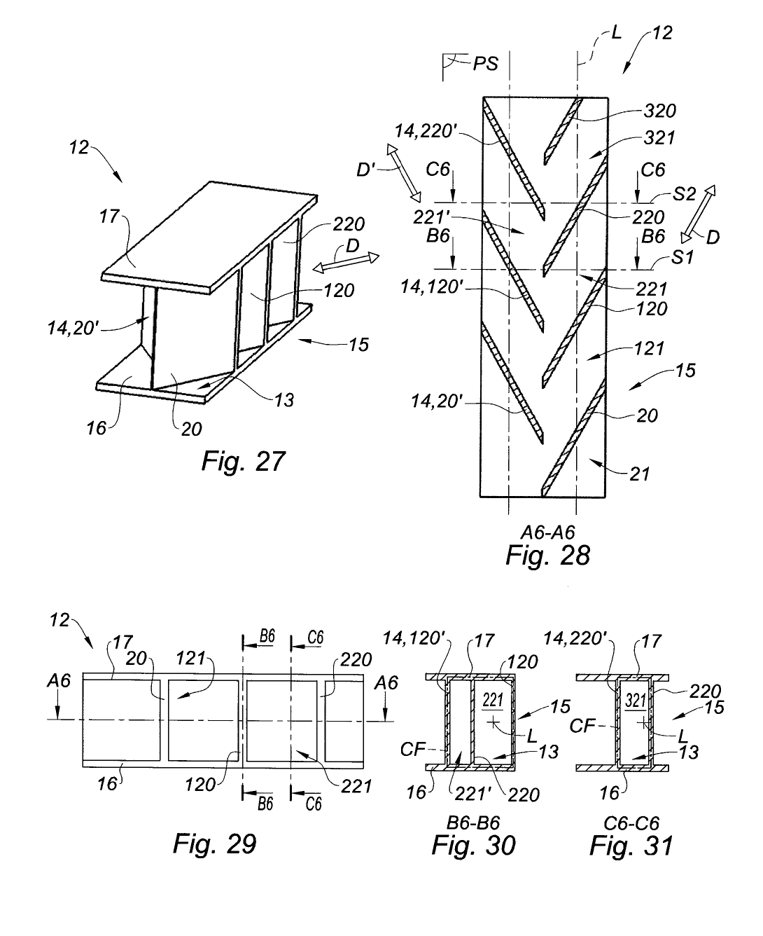

According to a last alternative embodiment, illustrated in FIGS. 27 to 31, the bottom wall 14 may be divided, rather than being solid and continuous over the length of the reinforced segment 12 as preferably illustrated in FIGS. 4, 11, 14, 18 and 23 for example.

In particular, said bottom wall may be divided into a second series of reinforcement ribs 20′, 120′, 220′ positioned at a distance from the reinforcement ribs 20, 120, 220 of the first series and oriented along directions intersecting said ribs 20, 120, 220 of the first series.

The reinforcement ribs 20′, 120′, etc. of the second series will preferably have all or part of the features described in the foregoing with reference to the reinforcement ribs 20, 120 of the first series, notably as to the existence of their opening aperture 15′, here placed opposite said ribs 20, 120 of the first series, or as to their tilt and their spacing that enable forming, in cooperation with the ribs 20, 120 of the first series, closed contours CF in the sense of the invention (FIGS. 30 and 31).

Such an arrangement for example amounts to having both C-shaped grooves of FIGS. 22 and 26, back to back with each other, communicate freely with each other, by suppressing the intermediate partition.

Preferably, said ribs of the second series 20′, 120′, 220′ may be arranged with an angled pattern relatively to those of the first series 20, 120, 220, all gradually extending away from the mean line L, when said mean line is traveled along in a given direction.

The ribs 20′, 120′ of the second series may further be positioned staggered relatively to those 20, 120 of the first series.

More particularly, the second series being preferably with the same pitch, preferentially a constant pitch, as the first series, the longitudinal shift of the second series relatively to the first may be by one half-pitch.

Of course, it is possible to freely combine either one of the groove 13 orientations, with either one of the arrangements of the lever 6 or reinforcement ribs 20, 120, etc., or else adapt these arrangements and combinations to either one of the pedal alternatives, and/or to either one of the described sections notably straight pi, open pi (trapezium), U-shaped, C-shaped, I-shaped sections, etc.

Finally, the invention may also relate as such to a method for manufacturing a pedal 1 according to either one of the alternatives described in the foregoing, preferably by injection molding a plastic, composite or even metal material in a light alloy of the aluminum or magnesium type.

1. A pedal comprising a lever which longitudinally extends from a shoe, intended to receive a control force, to a articulating member intended to allow the pivoting of said pedal around a pivot axis, said pedal being wherein said lever has a hollow reinforced segment which comprises:
a groove on the one hand, which longitudinally extends along a mean line oriented from the shoe to the articulating member, said groove having a <<π-shaped>> cross-section so as to open on the outside of the lever through an aperture which extends along said lever on one of the sides of the latter, said groove being delimited, around the mean line and along the latter, by a bottom wall located opposite to the aperture relatively to the mean line of said groove, and by two side walls, i.e. a first side wall, a so-called <<left side wall>>, and a second side wall, a so-called <<right side wall>>, which extend from said bottom wall by laterally edging said groove on either side of the mean line, and
at least two successive reinforcement ribs, distant from each other, on the other hand, which extend obliquely relatively to the mean line, from the bottom wall towards the aperture and which each connect the left side wall to the right side wall so as to subdivide the groove into several cavities which open onto said aperture, said reinforcement ribs being sufficiently close to each other, in view of their tilt relatively to the mean line of the groove, for exhibiting along the groove, in an orthogonal projection on said mean line, partial longitudinal overlapping, so that, in each cross section of the reinforced segment occupied by said reinforcement ribs, the lever has at least one closed contour for torsional reinforcement, which is formed by the contiguous succession of the corresponding sections of the bottom wall, forming a first crosspiece, of the left side wall, forming a first upright, of a rib forming a second crosspiece, and of the right side wall forming a second upright, and which at least frames a cavity passage.

2. The pedal according to claim 1, wherein the reinforcement ribs each join the bottom wall as far as a free end which is located beyond half of the depth of the groove in the direction of the aperture, and which is flush with the edges of the left and right side walls.

3. The pedal according to claim 1, wherein each reinforcement rib forms a planar partition of substantially constant thickness, and in that the reinforcement ribs are parallel with each other.

4. The pedal according to claim 1 wherein some of the reinforcement ribs, the majority or even the totality of said reinforcement ribs are laid out perpendicularly to the left and right side walls.

5. The pedal according to claim 1, wherein the reinforcement ribs are made in one piece with the left and right side wall.

6. The pedal according to claim 1, wherein the reinforcement ribs are made in one piece with the bottom wall.

7. The pedal according to claim 1, wherein the bottom wall forms a plate which marks the limit, for example an upper limit, of the lever, and which juts out in width protruding from the left and right side walls.

8. The pedal according to claim 1, wherein the reinforcement segment covers at least 30%, of the length of the lever.

9. The pedal according to claim 1, wherein the filling level of the pedal, corresponding to the quotient of the solid volume of said pedal by the total volume of the covering of said pedal, is substantially comprised between 5% and 50%.

10. The pedal according to claim 1, wherein the lever, and the pedal as a whole, is entirely made in one piece in a material suitable for injection molding comprising at least one of a thermoplastic polymer, either filled with fibers or not, a composite material filled with fibers either woven or not, or a metal alloy of the aluminium or magnesium type.

11. The pedal according to claim 1, wherein at least one of the reinforcement ribs has tilt combined in roll, and then in pitch relatively to the mean line and in that this reinforcement rib with composed tilt is crossed with another rib also having a composed tilt in roll, of opposite sign, and then in pitch, so as to form, inside the groove, an oblique cross, the generatrix of which extents away from the bottom wall along a resulting tilt in pitch relatively to the mean line, and which opens onto the aperture.

12. The pedal according to one of the preceding claim 1, wherein the groove is laid around the mean line so as to have a C-shaped section, the aperture of which is located on the side of the lever, transversely to the pivot axis.

13. The pedal according to claim 1, wherein it comprises two grooves opposed by their common bottom wall so as to form a dual reinforcement segment having, according to the orientation, either an I-shaped section or an H-shaped section, both series of corresponding reinforcement ribs being laid out with a herringbone pattern.

14. The pedal according to claim 1, wherein the bottom wall is divided into a second series of reinforcement ribs positioned at a distance from the reinforcement ribs of the first series, and oriented along directions intersecting said ribs of the first series, the reinforcement ribs of the second series being laid out with a herringbone pattern and/or staggered relatively to the reinforcement ribs of the first series.

15. An automobile vehicle provided with a control pedal assembly comprising at least one pedal, a brake pedal, the pedal being according to claim 1.
